(19) United States
(12) Patent Application Publication
(10) Pub. No.: US 2026/0095000 A1
(43) Pub. Date: Apr. 2, 2026

(54) ELECTRICAL CONNECTOR WITH IMPROVED SHIELDING STRUCTURE

(71) Applicants: APTIV CONNECTION SYSTEMS (NANTONG) LTD., Jiangsu (CN); APTIV ELECTRICAL CENTERS (SHANGHAI) CO. LTD., Shanghai (CN)

(72) Inventors: Haodong SHI, Shanghai (CN); Mei YE, Shanghai (CN); Haifei GUAN, Shanghai (CN)

(21) Appl. No.: 19/343,125

(22) Filed: Sep. 29, 2025

(30) Foreign Application Priority Data
Sep. 29, 2024 (CN) 202411376620.5

(51) Int. Cl. H01R 13/6581

(52) U.S. Cl. CPC H01R 13/6581; H01R 2201/04

(57) ABSTRACT

This disclosure relates to an electrical connector, such as a network connector. An electrical connector according to this disclosure includes an outer housing; and an inner-housing module for installation into the outer housing, the inner-housing module including an inner plastic shell, signal terminal installed within the inner plastic shell, and the inner-housing module further including an electrical shielding structure, wherein the electrical shielding structure includes a first shielding component and a second shielding component, wherein the first shielding component is to be mounted on a first side of the inner plastic shell, and the second shielding component is to be mounted on a second side of the inner plastic shell, the second side being opposite to the first side, wherein the first shielding component and the second shielding component are configured to provide complete shielding on the first and second sides of the inner plastic shell.

### CROSS-REFERENCE TO RELATED APPLICATION

This application claims the benefit of and priority to Chinese Patent Application No. 202411376620.5, filed Sep. 29, 2024, the contents of which are incorporated by reference herein.

### TECHNICAL FIELD OF THE INVENTION

This disclosure relates to the technical field of electrical connector, specifically to an electrical connector with an improved electrical shielding structure, particularly a network connector with an improved electrical shielding structure.

### BACKGROUND

Modern vehicles are equipped with an increasing number of onboard electronic devices. These electronic devices provide functions such as sensing, control, input, and output, which can then realize advanced functions such as consumer electronics, navigation control, and autonomous driving feedback control. In order to facilitate data communication between individual onboard electronic components, a data network has been established between various components of the vehicle using communication protocols such as Ethernet, which can achieve data rates of 100 Mb/s or even higher. A connector used for the on-vehicle data network can be referred to as a vehicle network connector or an in-vehicle ethernet connector.

Some high-speed network connectors have electrical shielding structures to ensure signal integrity and anti-interference. In such a network connector, the signal terminal is placed in an inner plastic shell, while a conductive shielding structure is disposed outside the inner plastic shell. An inner-housing module composed of the inner plastic shell and the conductive shielding structure is further disposed into the outer housing. However, due to restrictions such as compact space, the electrical shielding structure design of existing high-speed network connector is relatively simple, with insufficient overall coverage, and there are multiple obvious gaps in the shielding structure, resulting in local exposure of signal conductors, which leads to poor shielding effect of the existing shielding structure.

### SUMMARY

The purpose of this disclosure is to provide an electrical connector with an improved electrical shielding structure, in which a novel electrical shielding structure is used to surround the inner plastic shell, thereby achieving better shielding effect.

According to an aspect of this disclosure, an electrical connector is proposed, the electrical connector includes: an outer housing; and an inner-housing module for installation into the outer housing, the inner-housing module including an inner plastic shell, signal terminal installed within the inner plastic shell, and the inner-housing module further including an electrical shielding structure, wherein the electrical shielding structure includes a first shielding component and a second shielding component, wherein the first shielding component is to be mounted on a first side of the inner plastic shell, and the second shielding component is to be mounted on a second side of the inner plastic shell, the second side being opposite to the first side, wherein the first shielding component and the second shielding component are configured to provide complete shielding on the first and second sides of the inner plastic shell.

In the above-mentioned solution of electrical connector, optionally, the second shielding component is a lower shielding component including a wire compressing tail, and the first shielding component is an upper shielding component accommodated by the lower shielding component.

In the above-mentioned solution of electrical connector, optionally, the first shielding component is an upper shielding component, and the second shielding component is a lower shielding component including a wire compressing tail, the upper shielding component includes an upper shielding plate, and the lower shielding component includes a lower shielding plate and a pair of holding arms located on both sides of the lower shielding plate, each holding arm includes a vertical connecting plate and a horizontal pressing plate located at the end of the vertical connecting plate, the vertical connecting plate and the horizontal pressing plate are to hold the upper shielding plate of the upper shielding component.

In the above-mentioned solution of electrical connector, optionally, the upper shielding component further includes a pair of outwardly extending shielding spring arms provided on the sides of the upper shielding plate.

In the above-mentioned solution of electrical connector, optionally, the upper shielding plate includes a limiting hole, and the inner plastic shell is provided with an upper coupling protrusion that is to be interlocked with the limiting hole, the horizontal pressure plate of the holding arm at least partially covers the limiting hole of the upper shielding plate.

In the above-mentioned solution of electrical connector, optionally, the upper shielding plate further includes an upper wire shielding cover, which is to provide shielding for signal wire exposed outside the inner plastic shell.

In the above-mentioned solution of electrical connector, optionally, the lower shielding component further includes a lower shielding plate for covering the lower surface of the inner plastic shell, the lower shielding component further includes a lower wire shielding cover connected between the lower shielding plate and the wire compressing tail, wherein the lower wire shielding cover is to provide shielding for signal wire exposed outside the inner plastic shell.

In the above-mentioned solution of electrical connector, optionally, the upper wire shielding cover and the lower wire shielding cover cooperate to form a tapered space for accommodating signal wire.

In the above-mentioned solution of electrical connector, optionally, the lower shielding component includes a lower shielding plate, which is provided with one or more limiting holes, the inner plastic shell is provided with one or more upper coupling protrusions that are interlocked with the one or more limiting holes; the lower shielding plate is further provided with one or more lower shielding baffles for covering the one or more limiting holes on the lower shielding plate.

In the above-mentioned solution of electrical connector, optionally, the lower shielding component further includes a pair of front clamping arms, which are to fit into corresponding clamping grooves formed on both sides of the inner plastic shell.

In the above-mentioned solution of electrical connector, optionally, an opening is formed between the front clamping arm of the lower shielding component and the holding arm of the lower shielding component, and a pair of shielding spring arms are connected on both sides of the upper shielding component, and the shielding spring arm extends outward from the opening.

In the above-mentioned solution of electrical connector, optionally, the shielding spring arm includes a positioning plate and an extension portion, wherein the positioning plate includes a positioning hole, and the lateral side of the inner plastic shell is formed with a side coupling column corresponding to the positioning hole.

In the above-mentioned solution of electrical connector, optionally, a side limiting protrusion is formed on the lateral side of the inner plastic shell, and the side limiting protrusion provides a guiding slope for guiding the extension portion of the shielding spring arm to deflect outward.

In the above-mentioned solution of electrical connector, optionally, the electrical connector is a network connector.

In the above-mentioned solution of electrical connector, optionally, the signal terminal is a male terminal or a female terminal.

### BRIEF DESCRIPTION OF THE DRAWINGS

In order to provide a clearer explanation of the technical solution in the embodiments of the present disclosure, a brief introduction will be given to the drawings required for the description of the embodiments. It is apparent that the drawings described below are only some embodiments of the present disclosure. For those skilled in the art, other drawings can be obtained based on these drawings without creative labor.

FIG. 1 is an isometric drawing of the structure of a network connector according to some embodiments.

FIG. 2 is an exploded isometric drawing of the network connector according to some embodiments.

FIG. 3 is an isometric drawing of the structure of the inner-housing module composed of an inner plastic shell, an upper shielding component, and a lower shielding component according to some embodiments.

FIG. 4 is an isometric drawing of the mutual positional relationship between the upper shielding component, the lower shielding component, the signal terminal, and the cable according to some embodiments.

FIG. 5 is an isometric drawing of the structure of the signal terminal according to some embodiments.

FIG. 6 is an isometric drawing of the mutual positional relationship between the signal terminal and the cable according to some embodiments.

FIGS. 7 and 8 are isometric drawings of the structure of the inner plastic shell according to some embodiments.

FIGS. 9 and 10 are isometric drawings of the structure of the upper shielding component according to some embodiments.

FIGS. 11 and 12 are isometric drawings of the structure of the lower shielding component according to some embodiments.

### DETAILED DESCRIPTION

The following will provide a clear and complete description of the technical solution in the embodiments of the present disclosure, in conjunction with the accompanying drawings. Obviously, the described embodiments are only a part of the embodiments of the present disclosure, not all of them. Based on the embodiments in this disclosure, all other embodiments obtained by those skilled in the art without creative labor are within the scope of protection of this disclosure.

The directional terms mentioned in this disclosure, such as “up”, “down”, “front”, “back”, “left”, “right”, “inside”, “outside”, “side”, etc., are only the directions in the accompanying drawings. The directional terms used in this article are intended to explain and illustrate this disclosure, not to limit the scope of protection of this disclosure.

In the attached figure, components with the same structure are labelled with the same numbers, and components with similar structures or functions are labelled with similar numbers. In addition, for case of understanding and description, the size and thickness of each component shown in the accompanying drawings are arbitrarily illustrated, and this disclosure does not limit the size and thickness of each component.

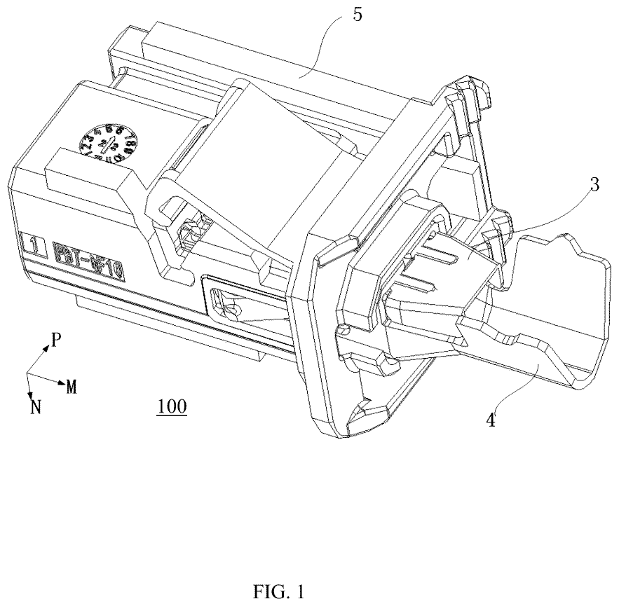

Referring to FIG. 1, a network connector 100 according to the embodiment of the present disclosure may be placed in a Cartesian coordinate system, which has a first direction M, a second direction N, and a third direction P orthogonal to each other. In this embodiment, in conjunction with FIG. 1, the first direction M corresponds to the insertion direction of the connector, the second direction N corresponds to the height direction of the connector, and the third direction P corresponds to the width direction of the connector.

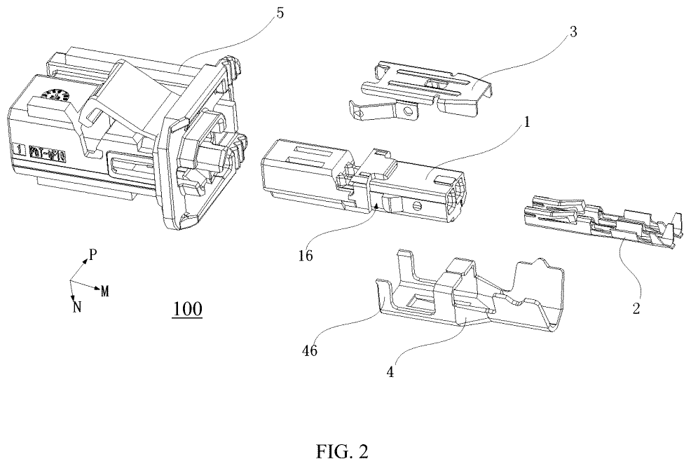

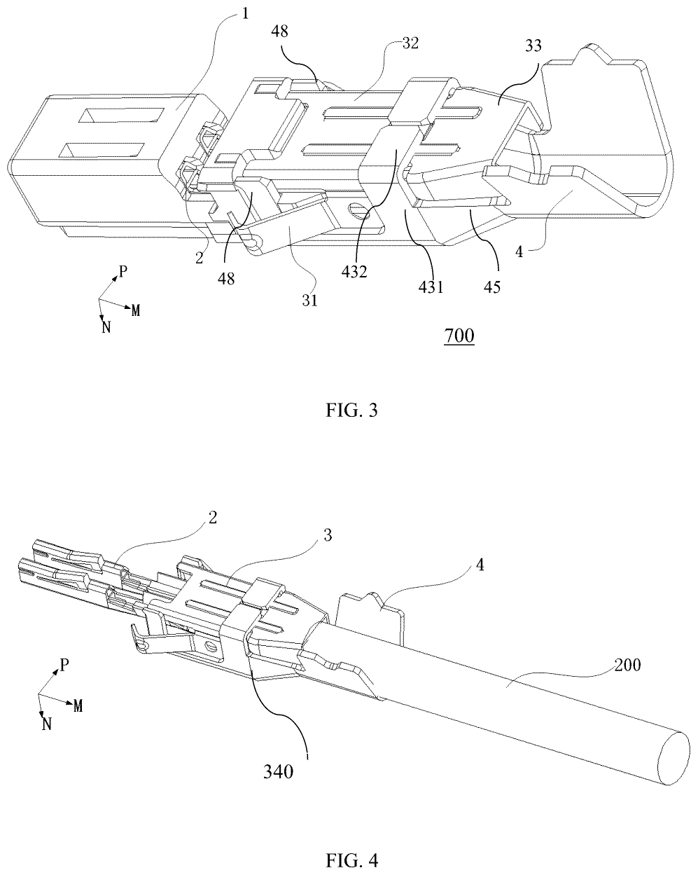

Referring to FIGS. 1 and 2, the network connector 100 may include: an outer housing 5, signal terminals 2, an inner plastic shell 1, an upper shielding component 3 surrounding the inner plastic shell 1, and a lower shielding component 4. Referring further to FIG. 3, an inner-housing module 700 shown in FIG. 3 is assembled by assembling the inner plastic shell 1, the upper shielding component 3, and the lower shielding component 4. Wherein the inner plastic shell 1 may include a plastic shell front portion 110 and a plastic shell rear portion 120, and in the inner-housing module 700, the upper shielding component 3 and the lower shielding component 4 surround the plastic shell rear portion 120 of the inner plastic shell 1 in a circumferential direction, while the plastic shell front portion 110 of the inner plastic shell is exposed to the outside.

Two signal terminals 2 can be terminated at the end of the signal wire in the cable and then installed into the inner-housing module 700. FIG. 4 shows the positional relationship between the cable 200, the signal terminal 2, the upper shielding component 3, and the lower shielding component 4 in an assembled state. In FIG. 4, in order to illustrate the signal terminal 2, inner plastic shell 1 has been removed.

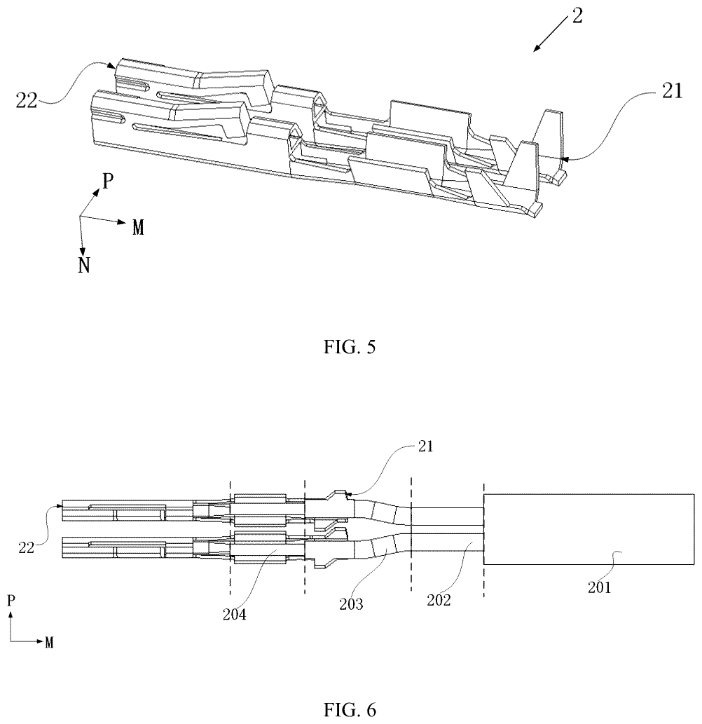

Referring further to FIGS. 5 and 6, two signal terminals 2 can be mounted at the ends of two signal wires 202 within the cable 200, and then the resulting signal wire terminated with signal terminal 2 can be inserted into a signal terminal channel in the inner plastic shell 1. Referring to FIG. 6, the cable 200 can be a signal cable, which includes a pair of signal wires 202 wrapped by an outer insulation layer 201. After peeling off the outer insulation layer 201 of cable 200, the pair of signal wires 202 inside are exposed. The exposed pair of signal wires 202 can be bent appropriately to increase their distance from each other, forming a signal wire branching section 203 shown in FIG. 6. Then, the pair of signal wires 202 signal wire branching section 203 are each connected to a wiring tail end 21 of a corresponding signal terminal 2. An appropriate connection approach may be, for example, peeling off the insulation layer of the signal wire 202 to expose a conductive wire core 204, and then crimping the conductive wire core 204 to the wiring tail end 21 of the signal terminal 2.

The mating end 22 of the signal terminal 2 is located on a side opposite to the wiring tail end 21. When the signal terminal 2 is installed in the inner plastic shell 1, the mating end 22 is located in the terminal channel of the inner plastic shell 1, and when the network connector 100 is connected to a mating connector, the mating end 22 of the signal terminal 2 will be connected to a mating end of a signal terminal in the mating connector. For example, when the mating end 22 of signal terminal 2 shown in FIG. 5 is in the form of a female terminal, the mating end of the signal terminal in the mating connector can be in the form of a male terminal.

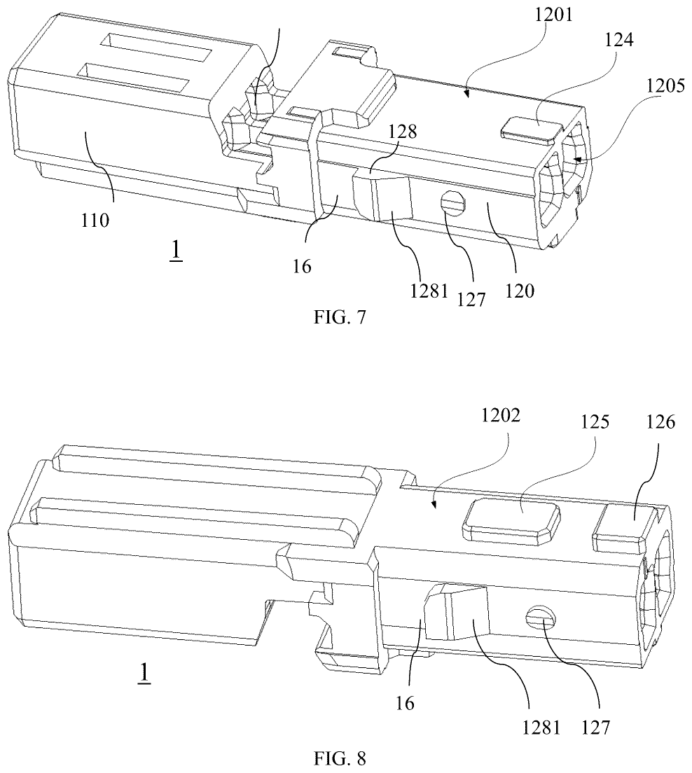

In the above embodiments, it can be understood that in the inner-housing module 700, the inner plastic shell I intends to provide fixature support for the signal terminal 2 and the signal wire 202, while the electrical shielding structure composed of the upper shielding component 3 and the lower shielding component 4 intend to provide the signal shielding effect required for high-speed transmission. The optional or preferred constructions of the inner plastic shell 1, upper shielding component 3, and lower shielding component 4 which make up the inner-housing module 700 in the embodiments according to the present disclosure will be described in conjunction with FIGS. 7 to 12.

FIG. 7 shows more details of the inner plastic shell 1 according to the embodiments of the present disclosure, while FIG. 8 presents more details of the inner plastic shell 1 from a perspective opposite to FIG. 7. As shown in FIGS. 7 and 8, the inner plastic shell 1 may include a plastic shell front portion 110 and a plastic shell rear portion 120. The plastic shell front portion 110 includes a front terminal channel 1105 for accommodating or partially accommodating the mating end 22 of the signal terminal 2, and the plastic shell rear portion 120 includes a rear terminal channel 1205 for accommodating or partially accommodating the wiring tail end 21 of the signal terminal 2.

In the inner plastic shell 1 shown in FIGS. 7 and 8, several positioning structures are provided on the outer surface of the plastic shell rear portion 120 for the mounting and positioning of the upper shielding component 3 and the lower shielding component 4. These positioning structures may include: an upper coupling protrusion 124 located on the upper surface 1201 of the plastic shell rear portion 120, a first lower coupling protrusion 125 and a second lower coupling protrusion 126 located on the lower surface 1202 of the plastic shell rear portion 120, a pair of side coupling columns 127 and a pair of side limiting protrusions 128 located on the left and right surfaces of the plastic shell rear portion 120.

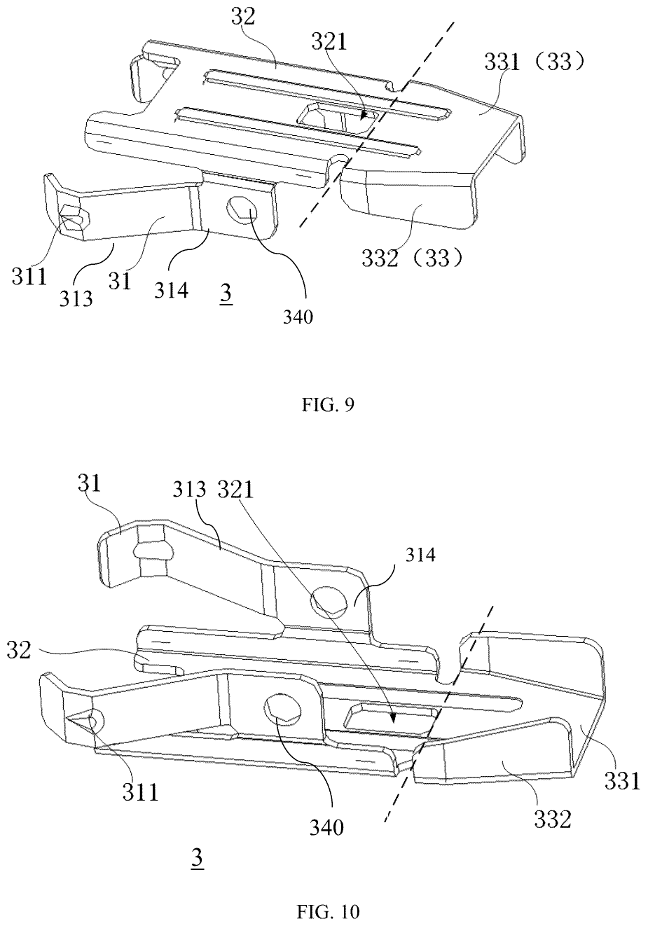

FIG. 9 shows more details of the upper shielding component 3 according to the embodiments of the present disclosure, while FIG. 10 presents more details of the upper shielding component 3 from the perspective opposite to FIG. 9.

Referring to FIGS. 9 and 10, the upper shielding component 3 includes an upper shielding plate 32 and two shielding spring arms 31 connected to both sides of the upper shielding plate 32. When the upper shielding component 3 and the inner plastic shell 1 are assembled together, the two shielding spring arms 31 are respectively disposed on the two sides of the inner plastic shell 1. More specifically, as shown in FIGS. 9-10, each shielding arm 31 includes a positioning plate 314 and an extension portion 313. A positioning hole 340 is formed on the positioning plate 314, which can form an assembly relationship with the side coupling columns 127 on the left and right sidewalls of the rear portion 120 of the inner plastic shell 1. At the end of the extension portion 313 of each shielding arm 31, at least one contact point protruding away from the inner plastic shell I can be formed for contacting a shielding plate in the mating connector (not shown). For example, as shown in FIGS. 9-10, each shielding arm 31 has one contact point 311.

In a further implementation, the upper shielding plate 32 is constructed to bend on both sides to form rolled edges, while the two shielding spring arms 31 are connected to the edges of the rolled edges.

When the upper shielding component 3 is installed on the inner plastic shell 1, the upper shielding plate 32 covers the upper surface 1201 of the plastic shell rear portion 120. This structure of the upper shielding plate 32 increases the coverage area of the shielding component on the inner plastic shell 1, enhancing the shielding effect of the shielding component.

Making further reference to FIGS. 9 and 10, a limiting hole 321 is provided on the upper shielding plate 32 of the upper shielding component 3. The upper coupling protrusion 124 on the inner plastic shell 1 is interlocked with the limiting hole 321. By interlocking the upper coupling protrusion 124 and the limit hole 321, the horizontal limiting of the upper shielding plate 32 is achieved to prevent horizontal displacement of the upper shielding plate 32. In other embodiments, the coupling protrusion can also be provided on the upper shielding plate 32, and the limiting hole can be provided on the inner plastic shell 1.

Making further reference to FIGS. 9 and 10, the upper shielding component 3 may also include an upper wire shielding cover 33. The upper wire shielding cover 33 does not cover the inner plastic shell 1, instead, it is used to provide shielding for signal wires exposed outside the inner plastic shell 1. Specifically, the upper wire shielding cover 33 is connected to the rear end of the upper shielding plate 32. The upper wire shielding cover 33 includes a first sub-shielding portion 331 and two second sub-shielding portions 332. The first sub-shielding portion 331 is connected to the upper shielding plate 32 and gradually narrows in the direction away from the upper shielding plate 32, forming a trapezoid. The two second sub-shielding portions 332 extend from both sides of the first sub-shielding portion 331 and bend to cover the left and right sides of the signal wire branching section 203. The upper wire shielding cover 33 thus provides a receiving space for accommodating the signal wire branching section 203, and in the direction away from the upper shielding plate 32, the receiving space gradually narrows. Therefore, the upper wire shielding cover 33 can conform to the spatial direction of the signal wire 202 from cable 200 to signal terminal 2, improving the shielding effect of the upper wire shielding cover 33.

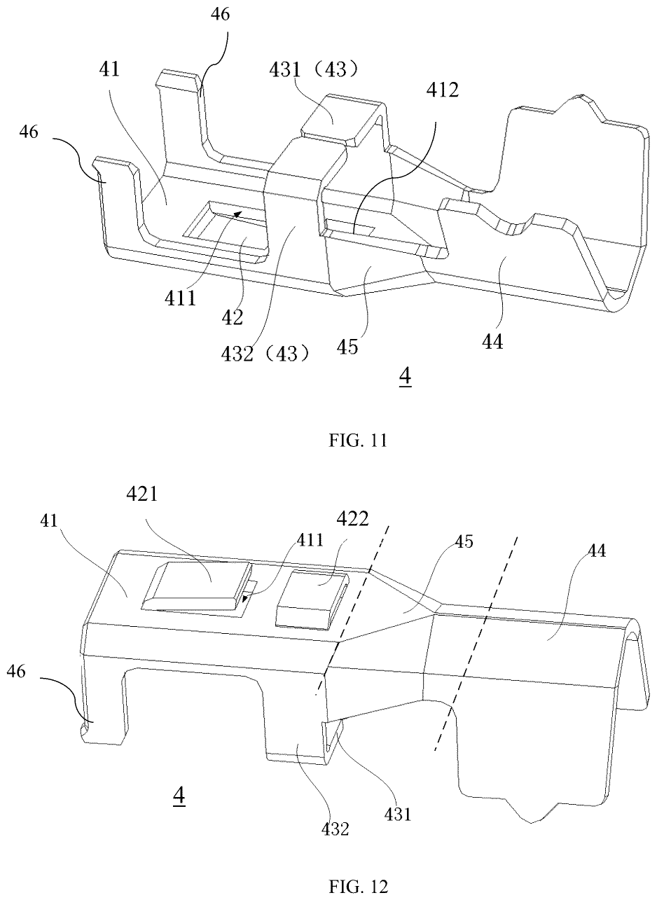

FIG. 11 shows more details of the lower shielding component 4 according to the embodiments of the present disclosure, while FIG. 12 presents more details of the lower shielding component 4 from the perspective opposite to FIG. 11.

Referring to FIGS. 11 and 12, the lower shielding component 4 includes a lower shielding plate 41, which is used to cover the lower surface 1202 of the rear portion 120 of the inner plastic shell 1. A limiting hole 411 is provided on the lower shielding plate 41, and the first lower coupling protrusion 125 on the lower surface 1202 of the inner plastic shell 1 is used to interlock with the limiting hole 411. By interlocking the first lower coupling protrusion 125 with the limiting hole 411, the horizontal limiting of the lower shielding plate 41 is achieved to prevent displacement of the lower shielding plate 41. Another limiting hole 412 can be provided on the lower shielding plate 41, and the second lower coupling protrusion 126 on the lower surface 1202 of the inner plastic shell 1 is used to interlock with the limiting hole 412. By interlocking the second lower coupling protrusion 126 with the limit hole 412, it is possible to further limit the horizontal position of the lower shielding plate 41 and prevent it from being displaced. In other embodiments, the limiting hole can also be located on the inner plastic shell 1, with the first lower coupling protrusion and the second lower coupling protrusion on the lower shielding plate 41.

Referring to FIGS. 11 and 12, the lower shielding component 4 may further include lower shielding baffles 421 and 422. The lower shielding baffle 421 covers the limiting hole 411, and the lower shielding baffle 422 covers the limiting hole 412. Thus, at the limiting holes 411 and 412, the insufficient shielding effect caused by the local opening on the lower shielding plate 41 is compensated for, that is, the overall shielding effect is enhanced.

Making further reference to FIGS. 11 and 12, the lower shielding component 4 may further include a pair of holding arms 43. Two holding arms 43 are respectively connected to the left and right ends of the lower shielding plate 41. Each holding arm 43 includes a vertical connecting plate 431 and a horizontal pressing plate 432. Referring to FIG. 3, the vertical connecting plate 431 and the horizontal pressing plate 432 can hold the upper shielding plate 32. Making further reference to FIG. 9, the horizontal pressing plates 432 of the two holding arms 43 can be constructed to cover or partially cover the limiting hole 321 provided on the upper shielding plate 32. Therefore, at the limiting hole 321 of the upper shielding plate 32, the insufficient shielding effect caused by the local opening of the upper shielding plate 32 is compensated for, that is, the overall shielding effect is enhanced.

Taking reference to FIGS. 11 and 12, the lower shielding component 4 may further include a pair of front clamping arms 46. The front clamping arms 46 are formed at the left and right ends of the lower shielding plate 41 and are closer to the front side of the lower shielding plate 41 than the holding arms 43. Referring to FIG. 3, with the help of the front clamping arms 46, the lower shielding component 4 further accommodates and positions the upper shielding component 3.

Making further reference to FIGS. 11 and 12, and in conjunction with FIG. 3, an opening is formed between the front clamping arm 46 and the holding arm 43 of the lower shielding component 4. When the upper shielding component 3 is accommodated and positioned within the lower shielding component 4, the positioning plate 314 of the shielding arm 31 of the upper shielding component 3 is located within the space enclosed by the lower shielding component 4, and the outwardly deflected extension portion 313 of the shielding spring arm 31 extends from the opening between the front clamping arm 46 and the holding arm 43 of the lower shielding component 4. Referring further to FIGS. 7 and 8, a side limiting protrusion 128 is formed on the left and right sides of the rear portion 120 of the inner plastic shell 1. The rear part of the side limiting protrusion 128 provides a guiding slope 1281 facing towards the rear side of the inner plastic shell 1, thereby guiding the extension portion 313 of the shielding spring arm 31 to rotate outward.

Referring to FIGS. 2 and 7, a stopping surface is formed at the front of the side limiting protrusion 128, which is perpendicular to the side of the inner plastic shell 1 and facing forward. The stopping surface on the side limit protrusion 128 and a second stopping surface arranged opposite it on the plastic shell rear portion 120 form an engaging groove 16. The front clamping arm 46 can be fitted into the clamping groove 16 to enhance the stability of the connection between the lower shielding component 4 and the inner plastic shell 1.

Making further reference to FIGS. 11 and 12, the lower shielding component 4 further includes a wire compressing tail 44, as well as a lower wire shielding cover 45 located between the lower shielding plate 41 and the wire compressing tail 44. As shown in FIG. 3, the lower wire shielding cover 45 does not cover the inner plastic shell 1, instead, it provides shielding for the signal wires exposed outside the inner plastic shell 1. Specifically, the lower wire shielding cover 45 is constructed such that when the lower shielding member 4 and the upper shielding member 3 are assembled together, the lower wire shielding cover 45 of the lower shielding member 4 surrounds the upper wire shielding cover 33 of the upper shielding member 3, thereby forming a gradually narrowing wire accommodation space that conforms to the spatial direction of each signal wire 202 from the signal terminal 2 to the cable 200. In other words, the upper wire shielding cover 33 and the lower wire shielding cover 45 cooperate to form a tapered space for accommodating signal wires.

As shown in FIG. 4, the wire compressing tail 44 can press the lower shielding component 4 onto the cable 200. For example, the wire compressing tail 44 can press the lower shielding component 4 onto an exposed shielding layer of cable 200, or onto a shielding ring fitted onto the shielding layer.

Furthermore, in conjunction with FIGS. 11 and 9, the width of the front side of the upper wire shielding cover 33 can be greater than the width of the rear side of the upper shielding plate 32, thereby forming a limiting applied to holding arm 43.

Referring further to FIGS. 1 and 2, the network connector 100 according to the embodiments of the present disclosure further includes an outer housing 5. The outer housing 5 is set outside the inner plastic shell 1 to protect the inner-housing module 700 composed of the inner plastic shell 1, the upper shielding component 3, and the lower shielding component 4.

In the above embodiment, the electrical shielding structure composed of the upper shielding component 3 and the lower shielding component 4 provides a more complete and tight shielding effect. For example, complete shielding is provided on both the upper and lower surfaces of the inner plastic shell 1, while eliminating or minimizing incomplete shielding caused by local opening or seam of the shielding component. On the lateral sides of the inner plastic shell, the holding arm and front clamping arm of the lower shielding component also provide better overall coverage, eliminating or minimizing the seam of the electrical shielding structure.

The network connector described in the above embodiments of the present disclosure may also be referred to as an Ethernet connector in some cases.

In the above embodiments of the present disclosure, the names of the upper shielding component and the lower shielding component are determined based on the observation perspective of the accompanying drawings. The names of the upper and lower shielding components can be interchanged according to practical disclosures or industry habits.

In the above embodiments of the present disclosure, the construction of a network connector is described with a female connector (i.e., female terminal is installed in the connector) as an example. It is appreciated that the network connector can be male connector (i.e., male terminal is installed in the connector).

In the above embodiments of the present disclosure, the present invention is described using a network connector as an example. It can be understood that a network connector is a type of connector that contains signal terminal. The concepts and ideas proposed in this disclosure can be more widely applied to electrical connectors including signal terminal and electrical shielding structure, regardless of whether the actual signal transmission disclosure they support are based on network protocol.

The above provides a detailed introduction to the electrical connector provided in this disclosure. Specific examples are used in this article to explain the principles and implementation methods of this disclosure. The above embodiments are only used to help understand the core idea of this disclosure; Meanwhile, for technical personnel in this field, there may be changes in the specific implementation methods and disclosure scope based on the ideas of this disclosure. Therefore, the content of this specification should not be understood as limiting this disclosure.

1. An electrical connector, comprising:
an outer housing; and
an inner-housing module for installation into the outer housing, the inner-housing module comprising an inner plastic shell, signal terminal installed within the inner plastic shell, and the inner-housing module further comprising an electrical shielding structure, wherein the electrical shielding structure comprises a first shielding component and a second shielding component, wherein the first shielding component is to be mounted on a first side of the inner plastic shell, and the second shielding component is to be mounted on a second side of the inner plastic shell, the second side being opposite to the first side and wherein the first shielding component and the second shielding component are configured to provide complete shielding on the first and second sides of the inner plastic shell.

2. The electrical connector according to claim 1, wherein the second shielding component is a lower shielding component comprising a wire compressing tail, and the first shielding component is an upper shielding component accommodated by the lower shielding component.

3. The electrical connector according to claim 1, wherein the first shielding component is an upper shielding component, and the second shielding component is a lower shielding component comprising a wire compressing tail and wherein the upper shielding component comprises an upper shielding plate, and the lower shielding component comprises a lower shielding plate and a pair of holding arms located on both sides of the lower shielding plate, each holding arm comprises a vertical connecting plate and a horizontal pressing plate located at an end of the vertical connecting plate, the vertical connecting plate and the horizontal pressing plate are to hold the upper shielding plate of the upper shielding component.

4. The electrical connector according to claim 3, wherein the upper shielding component further comprises a pair of outwardly extending shielding spring arms provided on the sides of the upper shielding plate.

5. The electrical connector according to claim 3, wherein the upper shielding plate comprises a limiting hole, and the inner plastic shell is provided with an upper coupling protrusion that is to be interlocked with the limiting hole and wherein a horizontal pressing plate of the holding arm at least partially covers the limiting hole of the upper shielding plate.

6. The electrical connector according to claim 3, wherein the upper shielding plate further comprises an upper wire shielding cover, which is to provide shielding for signal wire exposed outside the inner plastic shell.

7. The electrical connector according to claim 6, wherein the lower shielding component further comprises a lower shielding plate for covering a lower surface of the inner plastic shell and wherein the lower shielding component further comprises a lower wire shielding cover connected between the lower shielding plate and the wire compressing tail, wherein the lower wire shielding cover is to provide shielding for signal wire exposed outside the inner plastic shell.

8. The electrical connector according to claim 7, wherein the upper wire shielding cover and the lower wire shielding cover cooperate to form a tapered space for accommodating signal wire.

9. The electrical connector according to claim 2, wherein the lower shielding component comprises a lower shielding plate, which is provided with one or more limiting holes, the inner plastic shell is provided with one or more upper coupling protrusions that are interlocked with the one or more limiting holes and wherein the lower shielding plate is further provided with one or more lower shielding baffles for covering the one or more limiting holes on the lower shielding plate.

10. The electrical connector according to claim 3, wherein the lower shielding component further comprises a pair of front clamping arms, which are to fit into corresponding clamping grooves formed on both sides of the inner plastic shell.

11. The electrical connector according to claim 10, wherein an opening is formed between the front clamping arm of the lower shielding component and the holding arm of the lower shielding component, and a pair of shielding spring arms are connected on both sides of the upper shielding component, and the shielding spring arm extends outward from the opening.

12. The electrical connector according to claim 11, wherein the shielding spring arm comprises a positioning plate and an extension portion, wherein the positioning plate comprises a positioning hole, and a lateral side of the inner plastic shell is formed with a side coupling column corresponding to the positioning hole.

13. The electrical connector according to claim 12, wherein a side limiting protrusion is formed on the lateral side of the inner plastic shell, and the side limiting protrusion provides a guiding slope for guiding the extension portion of the shielding spring arm to deflect outward.

14. The electrical connector according to claim 1, wherein the electrical connector is a network connector.

15. The electrical connector according to claim 1, wherein the signal terminal is a male terminal or a female terminal.
